(19) United States
(12) Patent Application Publication
(10) Pub. No.: US 2023/0058958 A1
(43) Pub. Date: Feb. 23, 2023

(54) ARTICLE AND METHOD OF MAKING ARTICLE

(71) Applicant: Factorial Inc., Woburn, MA (US)

(72) Inventors: Jia Du, Woburn, MA (US); Dong Ren, Woburn, MA (US)

(73) Assignee: Factorial Inc., Woburn, MA (US)

(21) Appl. No.: 17/395,477

(22) Filed: Aug. 6, 2021

(51) Int. Cl. H01M 10/0565; C08F 222/18; C08F 230/08; C08F 222/22; C08F 222/10; H01M 10/0525; H01M 4/58; H01M 4/505; H01M 4/525

(52) U.S. Cl. CPC H01M 10/0565; C08F 222/18; C08F 230/085; C08F 222/22; C08F 222/1063; H01M 10/0525; H01M 4/5825; H01M 4/505; H01M 4/525; C08F 2810/20; H01M 2300/0082; H01M 2300/0091

(57) ABSTRACT

An article includes a polymer. The polymer includes a product of a crosslinking reaction including at least one cross-linker selected from the group consisting of: a) di-acrylates, tri-acrylates, and tetra-acrylates; b) modified tri-acrylates and tetra-acrylates; c) silanes and siloxanes; and d) triazinane-triones.

### FIELD

The present invention generally relates to various polymer solid electrolyte materials suitable for electrochemical devices such as batteries, capacitors, sensors, condensers, electrochromic elements, photoelectric conversion elements, etc.

### BACKGROUND

Battery technologies have transformed themselves again and again over the past five decades. As the field of electrical energy storage continues to grow and be widely applied, the demand for lithium-ion battery (LIB) performance continues to be higher and higher. Cycle life is pushed from thousands of cycles to a million cycles; energy density has advanced to approach 500 Wh/kg; the cost of high-performing batteries is incrementally decreasing, approaching as low as $100/Wh. With such high demand for LIB performance, the performance limit of current LIB system, i.e. lithium metal oxide cathode paired with a graphite anode in liquid carbonate electrolyte, is imminent and only minute improvement can be made to further its performance. However, safety concerns also come with the performance improvement of LIBs. As LIBs become higher and higher in energy density, the energy packed within a given space is increased and failure of such LIB would cause serious safety concerns.

Accompanying the rise of energy densities of lithium-ion batteries (LIBs) and the expansions of scale, finding a solution to the safety concerns of LIBs becomes more important for LIB development. Safety issues existing in LIBs may arise from the use of mixed flammable solvents such as carbonate/ether as solvent systems, which, in the case of overcharging, short-circuiting, over-heating, etc. can lead to serious accidents from LIBs catching on fire, burning or even exploding, etc.

### SUMMARY

The present invention generally relates to various polymer solid electrolyte materials. The subject matter of the present disclosure involves, in some cases, interrelated products, alternative solutions to a particular problem, and/or a plurality of different uses of one or more systems and/or articles.

In one aspect, the present invention is generally directed to an article including a polymer. The polymer includes a product of a crosslinking reaction including at least one cross-linker selected from the group consisting of: a) di-acrylates, tri-acrylates, and tetra-acrylates; b) modified tri-acrylates and tetra-acrylates; c) silanes and siloxanes; and d) triazinane-triones.

In another aspect, the present invention is generally directed to an electrochemical device including the article mentioned above.

In yet another aspect, the present invention is generally directed to a method of making an article. In one set of embodiments, the method includes mixing a composition including at least one cross-linker with a solvent to form a slurry, and curing the slurry by UV curing or by thermal curing. In some cases, the cross-linker is selected from the group consisting of: a) di-acrylates, tri-acrylates, and tetra-acrylates; b) modified tri-acrylates and tetra-acrylates; c) silanes and siloxanes; and d) triazinane-triones.

In another aspect, the present invention encompasses methods of making one or more of the embodiments described herein, for example, polymer solid electrolyte materials. In still another aspect, the present invention encompasses methods of using one or more of the embodiments described herein, for example, polymer solid electrolyte materials.

Other advantages and novel features of the present invention will become apparent from the following detailed description of various non-limiting embodiments of the invention when considered in conjunction with the accompanying figures.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 illustrates the capacity retention test curves of certain embodiments of the disclosure.

FIG. 2 illustrates the capacity retention test curves of certain embodiments of the disclosure.

FIG. 3 illustrates the capacity retention test curves of certain embodiments of the disclosure.

FIG. 4 illustrates the capacity retention test curves of certain embodiments of the disclosure.

FIG. 5 illustrates the electrochemical stability test curves of certain embodiments of the disclosure.

### DETAILED DESCRIPTION

The present invention generally relates an article. The article may be various polymer solid electrolyte materials suitable for various electrochemical devices. Certain aspects include a polymer, a plasticizer, and an electrolyte salt. In some cases, the polymer may include a product of a crosslinking reaction including at least one cross-linker. The cross-linker may be selected from the group consisting of:

a) di-acrylates, tri-acrylates, and tetra-acrylates:

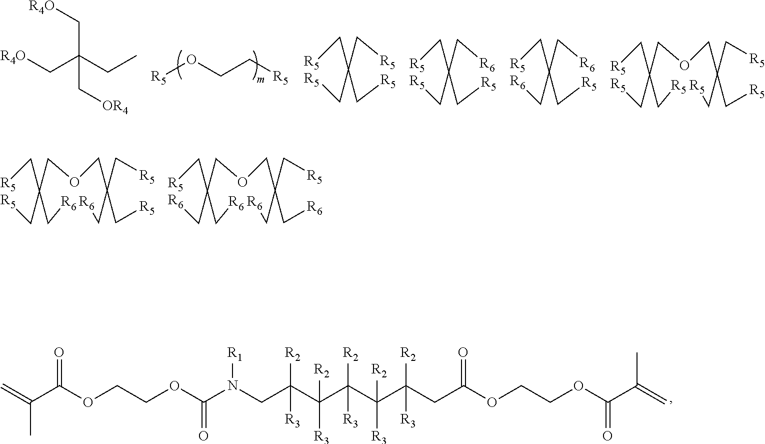

wherein R₁, R₂, R₃, R₆ are each independently selected from the group consisting of:

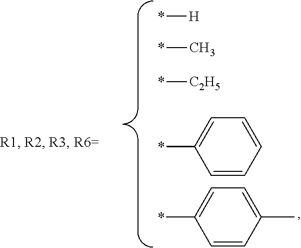

wherein R₄ is independently selected from the group consisting of:

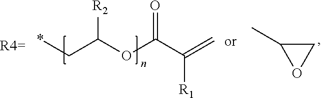

wherein R₅ is independently selected from the group consisting of:

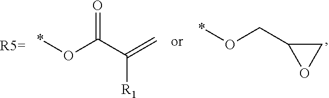

wherein m and n are respectively an integer between 0 and 50,000;

b) modified tri-acrylates and tetra-acrylates (the modification may be through halogenation and/or functionalization):

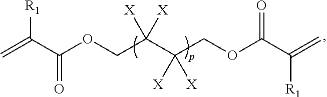

wherein p is an integer between 0 and 50,000,

wherein X is independently selected from the group consisting of:

X=—CN, —SO₂H, —CO₂H, —CO₂R₁, F, Cl, Br, I,

wherein R₁ is independently selected from the group consisting of:

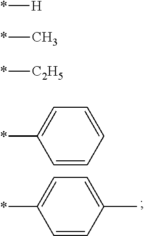

c) silanes and siloxanes:

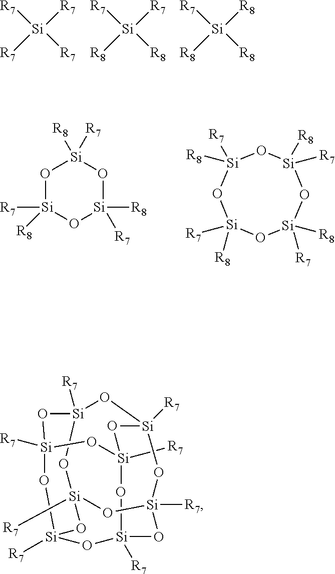

wherein R₇ is independently selected from the group consisting of:

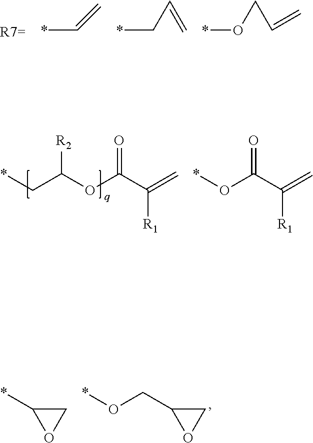

wherein R₁ and R₂ are each independently selected from the group consisting of:

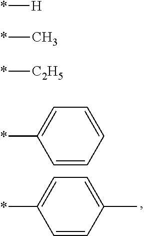

wherein q is an integer between 0 and 50,000,

wherein R₈ is independently selected from the group consisting of:

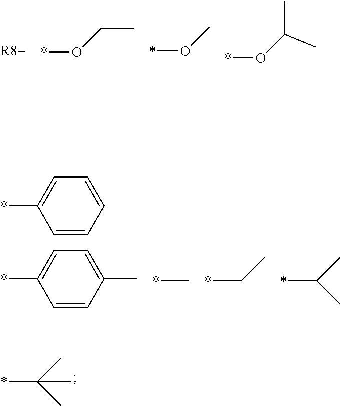

and

d) triazinane-triones:

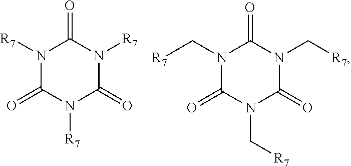

wherein R₇ is independently selected from the group consisting of:

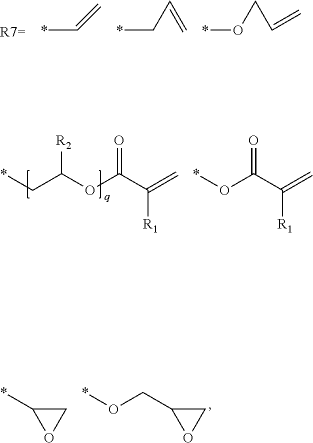

wherein * indicates a point of attachment,

wherein R₁ and R₂ are each independently selected from the group consisting of:

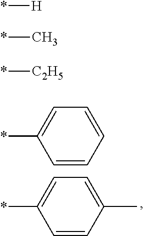

wherein q is an integer between 0 and 50,000.

In addition, certain embodiments are directed to compositions for use with polymer solid electrolytes, batteries, or other electrochemical devices including such polymer solid electrolytes, and methods for producing such polymers. In some cases, the incorporation of vinyl and/or allyl functional groups with UV crosslinking or thermal crosslinking can be used to improve various electrochemical performance, especially when the cross-linker has vinyl and/or allyl functional groups in at least three directions of the chemical structure of the cross-linker (i.e. the cross-linker has three cross-linkable terminals), the electrochemical performance can be improved much more obviously. In certain embodiments, some polymer solid electrolytes may be used to achieve safer, longer-life lithium batteries. The electrolytes may exhibit better ionic conductivity. These properties may benefit charging/discharging rate performances. In addition, the improved decomposition potential of the polymer materials may provide enhanced stability in a solid state electrolyte, which may provide for longer-life and/or higher voltage lithium batteries.

Thus, in some aspect, the present disclosure is generally directed to an electrochemical cell, such as a battery, including a polymer solid electrolyte material such as those discussed herein. In one set of embodiments, the battery is a lithium-ion battery, such as a lithium-ion solid-state battery. The electrochemical cell may also include an anode, a cathode, a separator, etc. Many of these are available commercially. The polymer solid electrolyte material may be used as the electrolyte of the electrochemical cell, alone and/or in combination with other electrolyte materials.

One aspect, for instance, is generally directed to solid electrolytes including certain polymers that can be used within electrochemical devices, for example, batteries such as lithium-ion batteries. Such electrochemical devices will typically include one or more cells, including an anode and a cathode, separated by an electrolyte. In comparison to liquid electrolytes, solid polymer electrolytes may be lightweight and provide good adhesiveness and processing properties. This may result in safer batteries and other electrochemical devices. In some cases, the polymer electrolyte may allow the transport of ions, e.g., without allowing transport of electrons. The polymer electrolyte may include a polymer and an electrolyte. The electrolyte may be, for example, a lithium salt, or other salts such as those discussed herein.

Certain embodiments of the invention are generally directed to solid electrolytes having relatively high ionic conductivity and electrical properties, e.g., decomposition potential. In some cases, for example, a polymer may exhibit improved properties due to the addition of at least three cross-linkable terminals at three directions and no poly (ethylene oxide) polymer chain (i.e. free of poly (ethylene oxide) polymer chain) in the chemical structure of the cross-linker.

In some embodiments, groups such as vinyl and/or allyl may be present as the cross-linkable terminals.

In addition, in one set of embodiments, functional groups such as vinyl and/or allyl may be crosslinked together, e.g., as described herein. For example, such functional groups may be crosslinked together using UV light, exposure to elevated temperatures (e.g., between temperatures of 20° C. and 100° C.), or other methods including those described herein. In some cases, the incorporation of three cross-linkable terminals can improve electrochemical performances, or the like, such as relatively high ionic conductivities, decomposition voltages, or the like.

In some cases, the degree of crosslinking may be determined. The degree of crosslinking is generally defined by the ratio between the reacted vinyl and/or allyl groups and the original vinyl and/or allyl groups. The weight or molar percentage of the cross-linker in the formulation can be assumed to control the degree of crosslinking, assuming that all of the vinyl and/or allyl groups have been reacted. In some cases, at least 1%, at least 3%, or at least 5% of the cross-linker has been crosslinked.

In some cases, solid electrolytes such as those described herein may provide certain beneficial properties, such as surprisingly high ionic conductivities, compared to other solid electrolytes. For example, the polymer solid electrolyte may exhibit ionic conductivities of at least 0.01 mS/cm, at least 0.05 mS/cm, at least 0.10 mS/cm, at least 0.15 mS/cm, at least 0.20 mS/cm, at least 0.25 mS/cm, at least 0.30 mS/cm, at least 0.35 mS/cm, at least 0.40 mS/cm, at least 0.45 mS/cm, at least 0.50 mS/cm, at least 0.55 mS/cm, at least 0.60 mS/cm, at least 0.65 mS/cm, at least 0.70 mS/cm, at least 0.75 mS/cm, at least 0.80 mS/cm, at least 0.91 mS/cm, at least 0.97 mS/cm, at least 1 mS/cm, at least 1.04 mS/cm, at least 1.05 mS/cm, at least 1.23 mS/cm, at least 1.26 mS/cm, at least 1.31 mS/cm, at least 1.33 mS/cm, at least 1.52 mS/cm, at least 1.80 mS/cm, or at least 2.0 mS/cm. In one embodiment, for example, the polymer solid electrolyte has ionic conductivity in between 0.01 mS/cm and 10 mS/cm at room temperature. In some cases, the cross-linker has at least three cross-linkable terminals, enabling it to crosslink from all four terminals rather than crosslinking linearly. Without wishing to be bound by any theory, it is believed that ionic conductivity is improved because there is no poly (ethylene oxide) polymer chain in the chemical structure of the cross-linker. The multiple cross-linkers can maintain high ionic conductivity of the polymer solid electrolyte, while minimizing the cross-linker amount.

As will be discussed below, Example 1, Example 8-4, Example 8-8, and Example 8-9 are single cross-linker systems, and their respective ionic conductivities show that both PETA and UDMA have improved ionic conductivities compared to DA700. The improved ionic conductivity from PETA is likely due to the tetraacrylate functionality, enabling it to crosslink from all four terminals rather than crosslinking linearly in DA700. As a result, less cross-linker of PETA is used in the formulation, enabling faster lithium ions transport than that in DA700 formulations. For Example 8-8 and Example 8-9, UDMA can better facilitate lithium ion transport from the amide functionality, which is electron-donating and can enable lithium ion transport.

Example 8-5, Example 8-6, and Example 8-7 are dual cross-linker systems, and they show slightly improved ionic conductivities compared to Example 8-4, which is a single cross-linker system. The second cross-linkers added in Example 8-5, Example 8-6, and Example 8-7 are allyl/vinyl terminated silanes, which can cross-link and potentially be used in silicon-anode battery systems as additives. It is likely that the addition of a second cross-linker to the electrolyte system disrupted the PETA crosslinking network, and a more disordered crosslinking network would likely lead to better ion transport, as ions can move more freely in the electrolyte. As the amount of the added cross-linkers are small, the disruption in ion transport property is also small, as observed.

In addition, in some embodiments, polymer solid electrolytes such as those described herein may provide relatively high decomposition voltages. Polymer solid electrolytes with relatively high decomposition voltages may be particularly useful, for example, in applications where higher voltages are required. In certain cases, the decomposition voltage of the polymer solid electrolyte may be at least 0.1 V, at least 0.2 V, at least 0.3 V, at least 0.4 V, at least 0.5 V, at least 0.6 V, at least 0.7 V, at least 0.8 V, at least 0.9 V, at least 1 V, at least 1.5 V, at least 2 V, at least 2.5 V, at least 3 V, at least 3.5 V, at least 3.8 V, at least 4 V, at least 4.3 V, at least 4.5 V, at least 4.8 V, at least 5V, at least 5.3V, at least 5.5 V, or at least 6 V. Decomposition voltages can be tested using standard techniques known to those of ordinary skill in the art, such as cyclic voltammetry. Without wishing to be bound by any theory, it is believed that the cross-linker is not easily oxidized when there is no poly (ethylene oxide) polymer chain in the chemical structure of the cross-linker, which may help the structure to resist decomposition and help the polymer solid electrolytes have relatively high decomposition voltage.

In one set of embodiments, the polymer solid electrolyte may include an additive, which may be useful for improve processability of the polymer solid electrolyte, and/or controlling the ionic conductivity and mechanical strength. For example, the additive may be a polymer, a small molecule (i.e., having a molecular weight of less than 1 kDa), a nitrile, an oligoether, cyclic carbonate, ionic liquids, or the like. Examples of the oligoether includes diethyl ether, 2-ethoxyethanol, dimethoxy methane, dimethoxy ethane, 1,2-diethoxyethane, 1,1-diethoxyethane, 1,1-dipropoxy-ethane, 1,2-dipropoxy-ethane, diethylene glycol, 2-(2-ethoxyethoxy)ethanol, diethylene glycol dimethyl ether, diethylene glycol diethyl ether, diethylene glycol dibutyl ether, triethylene glycol, tri(ethylene glycol) monomethyl ether, tri(ethylene glycol) monoethyl ether, tri(ethylene glycol) monobutyl ether, triethylene glycol dimethyl ether, triethylene glycol diethyl ether, diethylene glycol dibutyl ether, tetraethylene glycol, tetra(ethylene glycol) monomethyl ether, tetra(ethylene glycol) monoethyl ether, tetra(ethylene glycol) monobutyl ether, tetraethylene glycol dimethyl ether, tetraethylene glycol diethyl ether, tetraethylene glycol dibutyl ether, or the like. Non-limiting examples of potentially suitable additives include ethylene carbonate, diethyle carbonate, dimethyl carbonate, ethyl methyl carbonate, propylene carbonate, fluoroethylene carbonate, vinylene carbonate, succinonitrile, succinonitrile, glutaronitrile, hexonitrile, malononitrile, dimethyl sulfoxide, prop-1-ene-1,3-sultone, sulfolane, ethyl vinyl sulfone, tetramethylene sulfone, vinyl sulfone, methyl vinyl sulfone, phenyl vinyl sulfone, N-propyl-N-methylpyrrolidinium bis(fluorosulfonyl)imide, 1-ethyl-3-methylimidazolium bis(fluorosulfonyl)imide, trimethyl phosphate, triethyl phosphate, poly(ethylene oxide), or the like. In some case, the additives may act as solvent. In some other case, the additives may act as plasticizer.

In some embodiments, the additive can be present at a weight percentage of at least 1 wt %, at least 2 wt %, at least 3 wt %, at least 4 wt %, at least 5 wt %, at least 6 wt %, at least 7 wt %, at least 8 wt %, at least 9 wt %, at least 10 wt %, at least 11 wt %, at least 12 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, or at least 85 wt %, based on a total weight of the electrolyte.

In some embodiments, an electrolyte salt may be present. The electrolyte salt may include a lithium salt. Specific non-limiting examples of lithium salts include lithium perchlorate (LiClO₄), lithium hexafluorophosphate (LiPF₆), lithiumborofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphates (LiPF₃(CF₂CF₃)₃), lithium bisperfluoro-ethysulfo-nylimide (LiBETI), lithium bis(trifluoromethanesulphonyl) imide, lithium bis(fuorosulphonyl)imide, lithium trifluoromethanesulfonimide (LiTFSI), lithium bis(fluo-rosulfonyl)imide (LiFSI), lithium difluoro(oxalato)borate (LiDFOB), LiC(CF₃SO₂)₃, LiF, LiCl, LiBr, LiI, Li₂SO₄, LiNO₃, Li₃PO₄, Li₂CO₃, LiOH, lithium acetate, lithium trifluoromethyl acetate, lithium oxalate, and a combination thereof.

In one set of embodiments, the electrolyte salt may be present at a mole fraction of at least 0.5 M, at least 1M, at least 1.5M, at least 2M, at least 2.5M, at least 3M, at least 3.5M, at least 4M, at least 4.5M, at least 5M, at least 5.5 M, at least 6M, at least 6.5 M, at least 7 M, at least 7.5 M, at least 8 M, at least 8.5 M, at least 9 M, at least 9.5 M, at least 10 M and/or no more than 0.5M, no more than 1M, no more than 1.5M, no more than 2M, no more than 2.5M, no more than 3M, no more than 3.5M, no more than 4M, no more than 4.5M, no more than 5M, no more than 5.5 M, no more than 6M, no more than 6.5 M, no more than 7 M, no more than 7.5 M, no more than 8 M, no more than 8.5 M, no more than 9 M, no more than 9.5 M, no more than 10 M.

In some embodiments, an initiator may be present. Specific non-limiting examples of initiators include Irgacure initiator, 2,2′-azobis(2-methylpropionitrile), benzoyl peroxide, cumene hydroperoxide, dicumyl peroxide, ter-butyl hydroperoxide, di-tert-butyl peroxide, 2,2′-azobis[2-(2-imidazoline-2-yl)propane] dihydrochloride, ammonium persulfate, anisoin, anthraquinone, benzophenone, benzoin methyl ether, 2-isopropylthioxanthone, 9,10-phenanthrenequinone, 3′-hydroxyacetophenone, 3,3′,4,4′-benzophenonetetreacarboxylic dianhydride, 2-benzoylbenzoic acid, (±)-camphorquinone, 2-ethylanthraquinone, 2-methylbenzophenone, 4-hydroxybenzophenone, 2-hydroxy-2-methylpropiophenone, benzoin isobutyl ether, 4,4′-bis(dimethylamino)benzophenone, 4,4′-dihydroxybenzophenone, 4-benzoyl 4′-methyldiphenyl sulfide, ferrocene, dibenzosuberenone, benzoin ethyl ether, benzil, methyl benzoylformate, 4-benzoylbenzoic acid, or other initiators known to those of ordinary skill in the art. In some cases, the initiator may be added to have a weight fraction (weight percentage) between 0.01 wt % and 5 wt %, or other suitable mole fractions to facilitate polymerization, based on a total weight of the polymer solid electrolyte.

In certain cases, a polymer, an additive, and an electrolyte salt may each present within the electrolyte material at any suitable concentration. In addition, one or more than one of these may be present, e.g., there may be more than one polymer, and/or more than one plasticizer, and/or more than one electrolyte salt.

In one set of embodiments, the cross-linker may be present at a weight percentage of at least 0.01 wt %, at least 0.02 wt %, at least 0.027 wt %, at least 0.03 wt %, at least 0.05 wt %, at least 0.1 wt %, at least 0.11 wt %, at least 0.12 wt %, at least 0.13 wt %, at least 0.15 wt %, at least 0.2 wt %, at least 0.3 wt %, at least 0.5 wt %, at least 1.0 wt %, at least 1.5 wt %, at least 2.0 wt %, at least 2.5 wt %, at least 3 wt %, at least 3.5 wt %, at least 4 wt %, at least 4.5 wt %, at least 5.0 wt %, at least 6.0 wt %, at least 7.0 wt %, at least 8.0 wt %, at least 9.0 wt %, at least 10 wt %, at least 11 wt %, at least 12 wt %, at least 13 wt %, at least 14 wt %, at least 15 wt %, at least 30 wt %, at least 40 wt %, at least 50 wt %, and/or no more than 0.01 wt %, no more than 0.02 wt %, no more than 0.027 wt %, no more than 0.03 wt %, no more than 0.05 wt %, no more than 0.1 wt %, no more than 0.11 wt %, no more than 0.12 wt %, no more than 0.13 wt %, no more than 0.15 wt %, no more than 0.2 wt %, no more than 0.3 wt %, no more than 0.5 wt %, no more than 1.0 wt %, no more than 1.5 wt %, no more than 2.0 wt %, no more than 2.5 wt %, no more than 3 wt %, no more than 3.5 wt %, no more than 4 wt %, no more than 4.5 wt %, no more than 5.0 wt %, no more than 6.0 wt %, no more than 7.0 wt %, no more than 8.0 wt %, no more than 9.0 wt %, no more than 10 wt %, no more than 11 wt %, no more than 12 wt %, no more than 13 wt %, no more than 14 wt %, no more than 15 wt %, no more than 30 wt %, no more than 40 wt %, no more than 50 wt %, based on a total weight of the electrolyte.

Combinations of any of one or more of the above ranges and intervals are also possible. For example, the composition may include a cross-linker (including more than one cross-linker) having a weight fraction between 1 wt % and 50 wt % (that is, the total cross-linker does not exceed 50%), an electrolyte salt (including more than one electrolyte salt) having a mole fraction between 1.0M and 4M. Without wishing to be bound by any theory, if the cross-linker concentration is too high, the solid electrolyte may be relatively soft, which could be harder to handle; however, if the cross-linker concentration is too high, the solid electrolyte may be very tough, easy to break during handling, and may not provide good adhesion.

Certain aspects of the present invention are generally directed to systems and methods for producing any of the polymer solid electrolytes discussed herein. For example, in one set of embodiments, a polymer may be produced by reacting various cross-linkers together.

In one set of embodiments, the cross-linker may be mixed with a solvent containing electrolyte salts to form a slurry, which can be cured to form a solid. In addition, in some cases, more than one cross-linker may be present in the slurry, e.g., a first cross-linker and a second cross-linker, which may be added to the slurry sequentially, simultaneously, etc. The cross-linkers may each independently be cross-linkers such as those described herein, and/or other suitable cross-linkers.

In some embodiments, the slurry may be cured to form a film, such as a solid-state film. For instance, the mixture can be formed into a film by curing, for example, using UV light, thermoforming, exposure to elevated temperatures, or the like. For example, curing may be induced using exposure to UV light for at least 3 min, at least 5 min, at least 10 min, at least 15 min, etc., and/or by exposure to temperatures of at least 20° C., at least 30° C., at least 40° C., at least 50° C., at least 60° C., at least 70° C., at least 80° C., at least 90° C., at least 100° C., at least 110° C., at least 120° C., at least 130° C., at least 140° C., at least 150° C., etc. As an example, a slurry may be coated or positioned on a surface and/or within a mold and exposed to UV light to cause the polymer to cure.

In addition, in some cases, during the curing process, at least some of the cross-linkers may also cross-link, e.g., as discussed herein, which in some cases may improve various electrochemical performance. For example, exposure to UV light may facilitate the cross-linking process. As another example, thermal crosslinking may be used.

The present disclosure generally relates to a device with various polymer solid electrolyte materials mentioned above. The device may be a battery. The battery may be a battery, or a lithium-ion battery or a lithium-ion solid-state battery. The battery may be configured for applications such as, portable applications, transportation applications, stationary energy storage applications, and the like. Non-limiting examples of the ion-conducing batteries include lithium-ion conducting batteries, and the like. The device may also be a battery comprising one or more lithium ions electrochemical cells.

In various examples, a battery includes an electrolyte of the present disclosure, an anode, and a cathode with an electroactive material.

In various examples, the anode includes carbon anode, Li anode, Si anode, Alloy anode, and/or conversion anode materials. The carbon anode includes graphite, soft carbon, hard carbon, or combinations of thereof. The Li anode includes Li metal foil, Li metal on Cu (or on other current collectors, such as stainless steel, Ni). The Si anode includes Si, Si/Carbon composite anode, SiOₓ (0≤x<2), SiOₓ((0≤x<2)/carbon composite anode. The Alloy anode includes Sn, SnO₂, Sb, Al, Mg, Bi, In, As, Zn, Ga, B. In various examples, a battery is anode free (only includes current collector)

The conversion anode materials include MₐX_{b}, M is Mn, Fe, Co, Ni, Cu, and X is O, S, Se, F, N, P, etc. In addition, a and b are respectively 1 to 4.

In various examples, other possible anode materials include Li₄Ti₅O₁₂.

In various examples, the electroactive material includes lithium nickel cobalt manganese oxide, lithium nickel cobalt aluminum oxide, lithium titanate, metallic lithium, lithium metal oxide, lithium manganese oxide, lithium cobalt oxide, and lithium iron phosphate.

In addition, in some embodiments, the electrochemical device has a capacity retention of 90.7% to 100% after 87 cycles using a discharging current at a rate of 0.5 C at 25° C. or has a capacity retention of at least 99.2% after 73 cycles using a discharging current at a rate of 0.5 C at 25° C.

In addition, in some embodiments, the electrochemical device has a capacity retention of at least 41%, at least 46%, at least 51%, at least 56%, at least 62%, at least 67%, at least 72%, at least 77%, at least 82%, at least 87%, at least 90.7%, at least 92%, at least 95%, at least 97%, at least 99.2%, at least 99.3%, at least 99.5% or the like when a discharging current rate of 0.5 C being used at 25° C.

In addition, in some embodiments, the electrochemical device has an exothermic reaction of at least 130° C., at least 140° C., at least 150° C., at least 160° C., at least 170° C., at least 180° C., at least 190° C., at least 200° C., at least 210° C., at least 220° C., at least 230° C., at least 240° C., or at least 250° C.

In addition, the present disclosure generally relates to a method of making an article (such as a polymer solid electrolyte). The method includes a step of mixing a composition including at least one cross-linker with a solvent to form a slurry and a step of curing the slurry by UV curing or by thermal curing to form a solid electrolyte. In some embodiments, the cross-linker may be selected from the group consisting of:

a) di-acrylates, tri-acrylates, and tetra-acrylates:

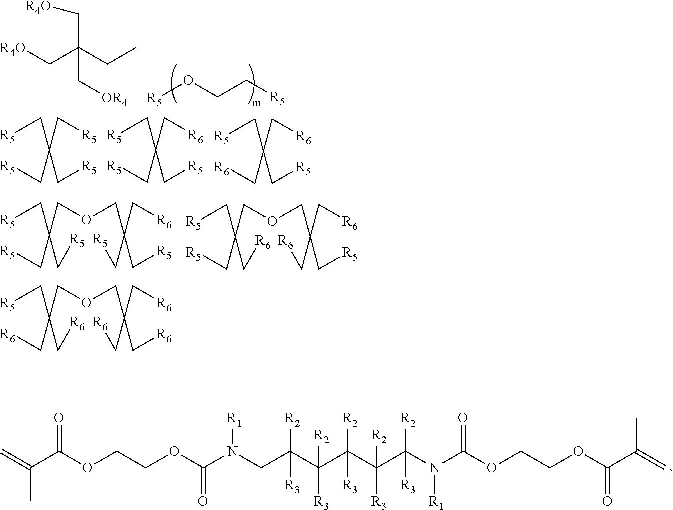

wherein R₁, R₂, R₃, R₆ are each independently selected from the group consisting of:

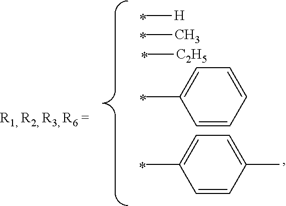

wherein R₄ is independently selected from the group consisting of:

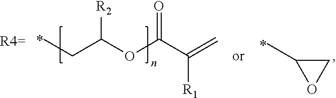

wherein R₅ is independently selected from the group consisting of:

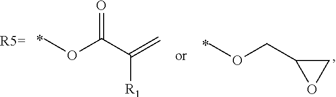

wherein m and n are respectively an integer between 0 and 50,000;

b) modified tri-acrylates and tetra-acrylates (the modification may be through halogenation and/or functionalization):

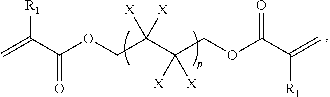

wherein p is an integer between 0 and 50,000,

wherein X is independently selected from the group consisting of:

X=—CN, —SO₂H, —CO₂H, —CO₂R₁, F, Cl, Br, I,

wherein R₁ is independently selected from the group consisting of:

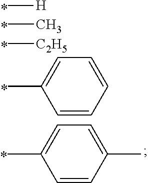

c) silanes and siloxanes:

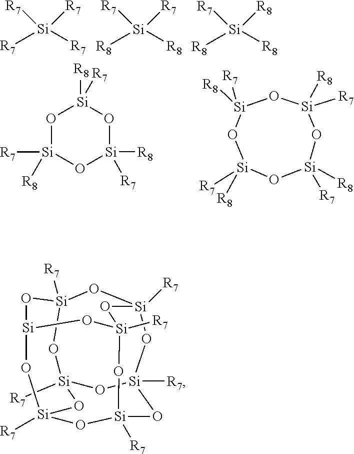

wherein R₇ is independently selected from the group consisting of:

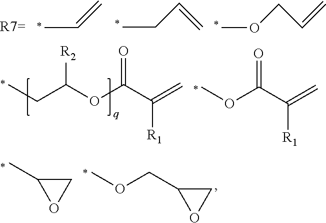

wherein R₁ and R₂ are each independently selected from the group consisting of:

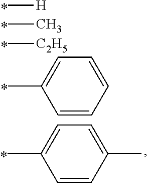

wherein q is an integer between 0 and 50,000,

wherein R₈ is independently selected from the group consisting of:

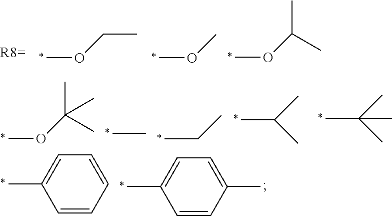

and

d) triazinane-triones:

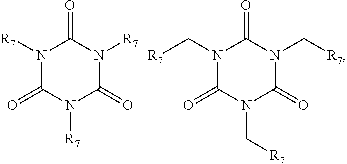

wherein R₇ is independently selected from the group consisting of:

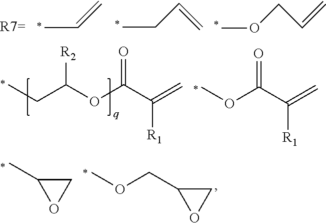

wherein * indicates a point of attachment,

wherein R₁ and R₂ are each independently selected from the group consisting of:

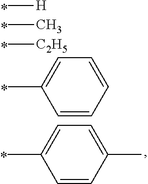

wherein q is an integer between 0 and 50,000.

In addition, in some embodiments, the method further comprising adding the slurry to a mold prior to curing the slurry, coating the slurry on a surface prior to curing the slurry. In some embodiments, only a first cross-linker is added. In some alternative embodiments, additional cross-linkers (such as a second cross-linker, a third cross-linker, and so on) may be added to the slurry prior to curing the slurry. In some embodiments, the additional cross-linker may be selected from the group consisting of:

a) di-acrylates, tri-acrylates, and tetra-acrylates:

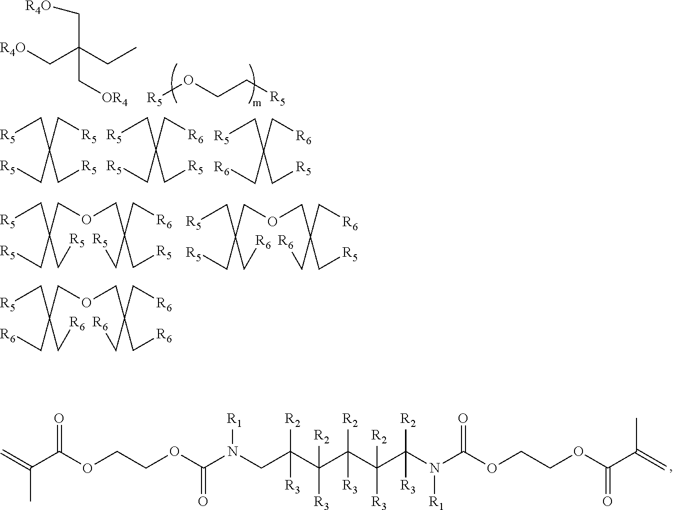

wherein R₁, R₂, R₃, R₆ are each independently selected from the group consisting of:

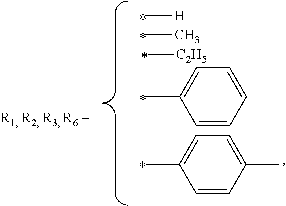

wherein R₄ is independently selected from the group consisting of:

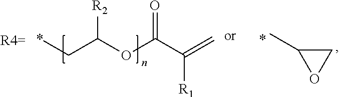

wherein R₅ is independently selected from the group consisting of:

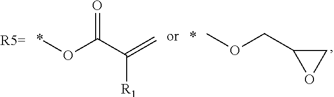

wherein m and n are respectively an integer between 0 and 50,000;

b) modified tri-acrylates and tetra-acrylates (the modification may be through halogenation and/or functionalization):

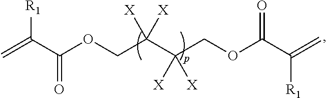

wherein p is an integer between 0 and 50,000,

wherein X is independently selected from the group consisting of:

X=—CN, —SO₂H, —CO₂H, —CO₂R₁, F, Cl, Br, I,

wherein R₁ is independently selected from the group consisting of:

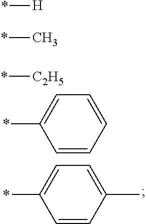

c) silanes and siloxanes:

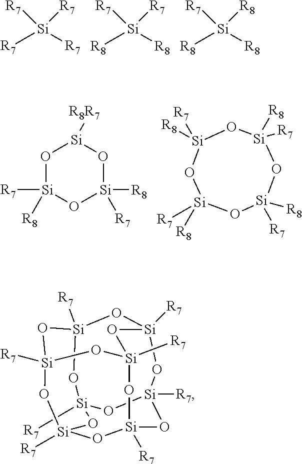

wherein R₇ is independently selected from the group consisting of:

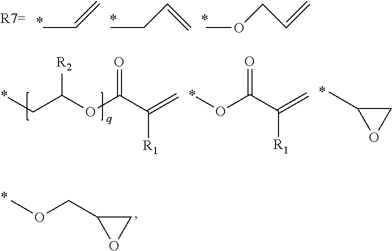

wherein R₁ and R₂ are each independently selected from the group consisting of:

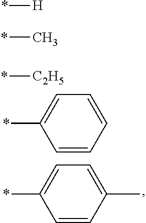

wherein q is an integer between 0 and 50,000,

wherein R₈ is independently selected from the group consisting of:

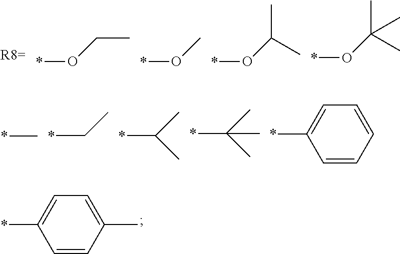

and

d) triazinane-triones:

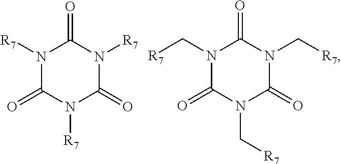

wherein R₇ is independently selected from the group consisting of:

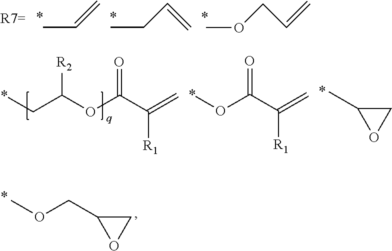

wherein * indicates a point of attachment,

wherein R₁ and R₂ are each independently selected from the group consisting of:

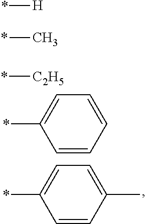

wherein q is an integer between 0 and 50,000.

In addition, in some embodiments, curing the slurry includes curing the slurry using UV curing or thermally curing, or curing the slurry includes exposing the slurry to a temperature between 50° C. and 90° C.

In addition, in some embodiments, the method of making a polymer solid electrolyte includes adding an initiator to the slurry, the initiator includes Irgacure initiator and/or 2,2′-azobis(2-methylpropionitrile), or any initiator mentioned above. In some embodiments, the method of making a polymer solid electrolyte includes adding additives to the slurry, the additives can be any additives mentioned above. In some embodiments, the method of making a polymer solid electrolyte includes adding an electrolyte salt to the slurry, the electrolyte salt can be any electrolyte salt mentioned above.

In some embodiments, the method of making a polymer solid electrolyte further includes adding the slurry to a mold prior to curing the slurry. In some embodiments, the method of making a polymer solid electrolyte further includes coating the slurry on a surface prior to curing the slurry.

U.S. Provisional Patent Application Ser. No. 62/757,133, filed Nov. 7, 2018, entitled “Polymer Solid Electrolytes,” by Huang, et al., is incorporated herein by reference in its entirety. Also incorporated herein by reference in their entireties are U.S. patent application Ser. No. 16/240,502, filed Jan. 4, 2019, entitled “Polymer Solid Electrolytes,” by Huang, et al., U.S. patent application Ser. No. 16/554,541, filed Aug. 28, 2019, entitled “POLYMER SOLID ELECTROLYTES, METHODS OF MAKING, AND ELECTROCHEMICAL CELLS COMPRISING THE SAME,” by Huang, et al. and International Patent Application Serial No. PCT/US19/12310, filed Jan. 4, 2019, entitled “Polymer Solid Electrolytes,” by Huang, et al.

The following examples are intended to illustrate certain embodiments of the present invention, but do not exemplify the full scope of the invention.

Cycling performance: A coin cell battery with a cathode, an anode, a separator, and an electrolyte was discharged and charged between various voltage ranges at room temperature using a Neware tester with various current rates. Cycle life is determined by the number of cycles for the battery cell to reach 80% of its original capacity (capacity retention).

Electrochemical Impedance Spectroscopy (EIS) and ionic conductivity: EIS was performed by AC impedance analyzer (Interface 1010E Potentiostate, Gamry) on an ionic conductivity cell. The frequency from 1 MHz to 1 Hz was applied in testing. An ionic conductivity cell is comprised of a stainless steels coin cell bottom, a silicone ring washer of known thickness and ring width, a gasket/O-ring a spacer, a spring, and a coin cell top. The electrolyte is placed within the ring of the silicone ring washer and bulk resistance from the measurement represents that of the electrolyte.

NMC811: lithium nickel manganese cobalt oxide (LiNi_{0.8}Mn_{0.1}Co_{0.1}O₂ in Example below)

NCA: lithium nickel cobalt aluminium oxide (LiNi_{0.8}Co_{0.15}Al_{0.05}O₂ in Example below)

SiOₓ: silicon monoxide (0≤x<2, x=1 in the examples below)

### Example 1

A solid-state polymer electrolyte was obtained by mixing a cross-linker (3 wt % DMA6C6F for Example 1-1, 5 wt % DMA6C6F for Example 1-2), 3.5M lithium salts (bis(fluorosulfonyl)imide, LiFSI), an additive, and an initiator (0.1 wt % AIBN) by mechanical stirring at room temperature.

The polymer solid electrolyte was assembled in a 2032-coin cell with SiOₓ as anode, and NCM as cathode, and the as-assembled cell was thermally cured at 60° C. for 1 to 2 hours. The cycling test was performed with a Neware cycling tester. All the batteries were tested using the same charging and discharging rate. The charge/discharge voltage window was from 2.8 V to 4.2 V. The battery was cycled at a current rate of 0.1 C from the first cycle to the third cycle, then the battery was cycled at a current rate of 0.2 C from the fourth cycle to the sixth cycle, then the battery was cycled at a current rate of 0.33 C from the seventh cycle to the ninth cycle, then the battery cycle at a current rate of 0.5 C for full cell.

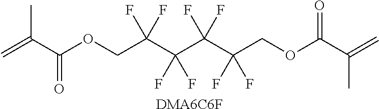

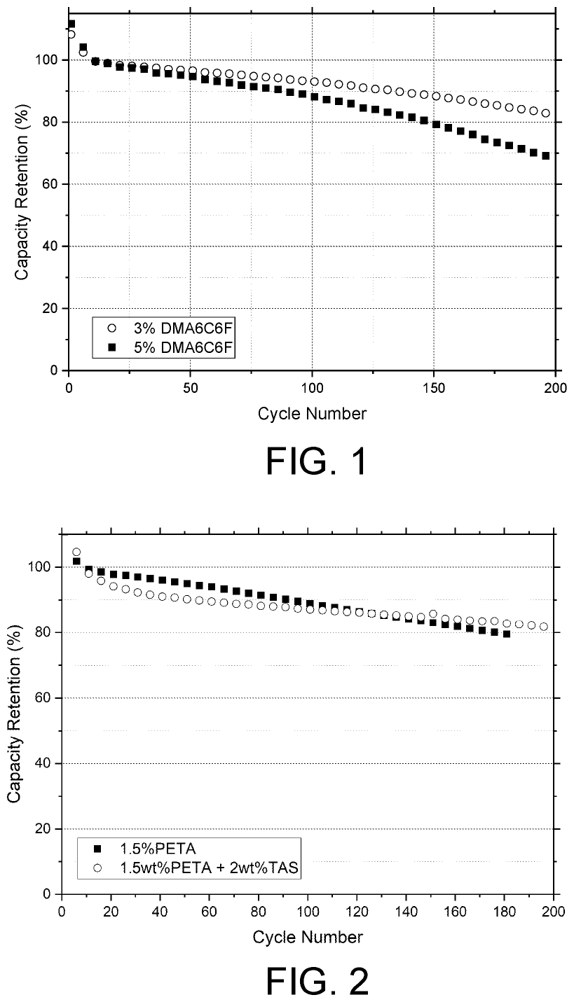

FIG. 1 shows the capacity retention of various amounts of cross-linker (DMA6C6F). At 200 cycles, Example 1-1 (with 3 wt % DMA6C6F) retains 82.5% of its original capacity, while Example 1-2 (with 5 wt % DMA6C6F) retains 68.3% of its original capacity. Example 1-2 (with 5 wt % DMC6C6F) has shown limited lithium-ion conduction in the polymer electrolyte. The result of this limitation in ion transport has led to a more rapid capacity fade as compared to Example 1-1 (with 3 wt % DMA6C6F). With optimal amount of DMA6C6F cross-linker, the cell performance can sustain better capacity retention and longer cycle life.

### Example 2

In Example 2, cross-linker 1 (2,2,3,3,4,4,5,5-octafluorohexane-1,6-diyl diacrylate, DA8C6F) and cross-linker 2 (2,2,3,3,4,4,5,5-octafluorohexane-1,6-diyl bis(2-methylacrylate), DMA8C6F) are respectively utilized.

A solid-state polymer electrolyte was obtained by mixing a single cross-linker (5 wt % of cross-linker 1 for Example 2-1, 10 wt % of cross-linker 1 for Example 2-2, 5 wt % of cross-linker 2 for Example 2-3, 10 wt % of cross-linker 2 for Example 2-4), 3.5M lithium salts (bis(fluorosulfonyl)imide, LiFSI), an additive, and 0.1 wt % initiator (2,2′-azobis(2-methylopropionitrile, AIBN) by mechanical stirring at room temperature in the liquid state, and the as-assembled cell was thermally cured at 60° C. for 1 to 2 hours. All the cross-linkers in Example 2-1, Example 2-2, Example 2-3, and Example 2-4 can crosslink very well.

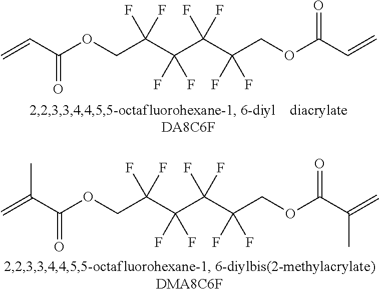

### Example 3

In Example 3, cross-linker 3 (tetraallyl silane), cross-linker 4 (diallyl dimethylsilane), cross-linker 5 (2,4,6,8-tetramethyl-2,4,6,8-tetravinylcyclotetrasiloxane), cross-linker 6 (allyltriethoxysilane), cross-linker 7 (poly(ethylene glycol) diacrylate (Mn 700)), and cross-linker 8 (pentaerythritol tetraacrylate) are utilized.

A solid-state polymer electrolyte was obtained by mixing two cross-linkers (2 wt % of cross-linker 3 and 5 wt % of cross-linker 7 for Example 3-1, 2 wt % of cross-linker 5 and 5 wt % of cross-linker 7 for Example 3-2, 2 wt % of cross-linker 4 and 5 wt % of cross-linker 7 for Example 3-3, 2 wt % of cross-linker 6 and 5 wt % of cross-linker 7 for Example 3-4, 2 wt % of cross-linker 3 and 2 wt % of cross-linker 8 for Example 3-5, 2 wt % of cross-linker 5 and 2 wt % of cross-linker 8 for Example 3-6), 3.5M lithium salts (bis(fluorosulfonyl)imide, LiFSI), an additive, and 0.1 wt % initiator (2,2′-azobis(2-methylopropionitrile, AIBN) by mechanical stirring at room temperature in the liquid state, and the as-assembled cell was thermally cured at 60° C. for 1 to 2 hours. All the cross-linkers in Example 3-1, Example 3-2, Example 3-3, Example 3-4, Example 3-5, and Example 3-6 can crosslink very well.

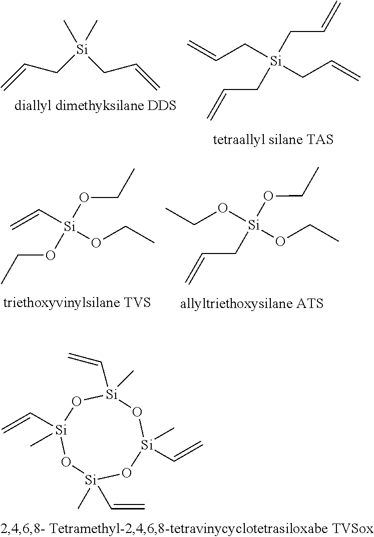

### Example 4

### Example 4-1

A solid-state polymer electrolyte was obtained by mixing 1.5 wt % of cross-linker 8 (pentaerythritol tetraacrylate, PETA), 3.5M lithium salts (bis(fluorosulfonyl)imide, LiFSI), and an additive by mechanical stirring at room temperature in the liquid state.

### Example 4-2

A solid-state polymer electrolyte was obtained by mixing 1.5 wt % of cross-linker 8 (pentaerythritol tetraacrylate, PETA) and 2 wt % of cross-linker 9 (Tetraallylsilane, TAS), 0.1 wt % initiator (2,2′-azobis(2-methylopropionitrile, AIBN), 3.5M lithium salts (bis(fluorosulfonyl)imide, LiFSI), and an additive by mechanical stirring at room temperature in the liquid state.

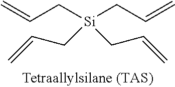

The liquid and viscous mixture mentioned above was directly applied onto a polyethylene terephthalate (PET) substrate. The coating was thermally cured at 60° C. for 1 to 2 hours.

The polymer solid electrolyte was assembled in a 2032-coin cell with SiOₓ as anode, and NCA815 as cathode, and the as-assembled cell was thermally cured at 60° C. for 1 to 2 hours. The cycling test was performed with a Neware cycling tester. All the batteries were tested using the same charging and discharging rate. The charge/discharge voltage window was from 2.8 V to 4.2 V. The battery was cycled at a current rate of 0.1 C from the first cycle to the third cycle, then the battery was cycled at a current rate of 0.2 C from the fourth cycle to the sixth cycle, then the battery was cycled at a current rate of 0.33 C from the seventh cycle to the ninth cycle, then the battery cycle at a current rate of 0.5 C for full cell.

FIG. 2 shows the capacity retention of the single cross-linker system (Example 4-1; PETA only) compared to dual cross-linker system (Example 4-2; PETA and TAS). The dual cross-linker system shows small improvement in capacity retention as compared to the single cross-linker system, retaining 82.9% after 180 cycles (comparing with 75.6% of the single cross-linker system). This improvement is likely due to the added cross-linker (cross-linker 9) disrupted the crosslinking network of the first cross-linker (cross-linker 8), making the polymer network more disordered. A disordered polymer network can better facilitate ion transport than an ordered polymer network. As only a small amount of second cross-linker (cross-linker 9) is added to the system, a small improvement is observed in the capacity retention of the resulting formulation

### Example 5

### Example 5-1

A solid-state polymer electrolyte was obtained by mixing 3 wt % of cross-linker (tris[2-(acryloyloxy)ethyl] isocyanurate, TAEI), 1 wt % initiator (2,2′-azobis(2-methylopropionitrile, AIBN), 3.5M lithium salts (bis(fluorosulfonyl)imide, LiFSI) and an additive by mechanical stirring at room temperature in the liquid state.

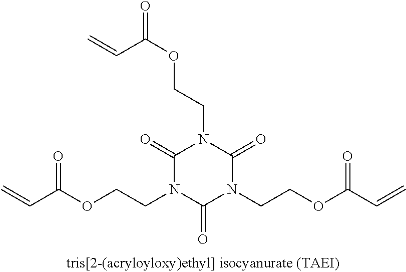 [SMILES: C=CC(=O)OCCn1c(=O)n(CCOC(=O)C=C)c(=O)n(CCOC(=O)C=C)c1=O]

### Example 5-2

A solid-state polymer electrolyte was obtained by mixing the 5 wt % of cross-linker (poly (ethylene glycol) diacrylate, Mn=700, DA700), 3.5M lithium salts (bis(fluorosulfonyl)imide, LiFSI), and an additive by mechanical stirring at room temperature in the liquid state.

The polymer solid electrolyte was assembled in a 2032-coin cell with Gr as anode, NCM811 as cathode, and NPore as separator, and the as-assembled cell was thermally cured at 60° C. for 1 to 2 hours. The cycling test was performed with a Neware cycling tester. All the batteries were tested using the same charging and discharging rate. The charge/discharge voltage window was from 2.8 V to 4.2 V. The battery was cycled at a current rate of 0.1 C from the first cycle to the third cycle, then the battery was cycled at a current rate of 0.2 C from the fourth cycle to the sixth cycle, then the battery was cycled at a current rate of 0.33 C from the seventh cycle to the ninth cycle, then the battery cycle at a current rate of 0.5 C for full cell.

The data for Example 5-2 was tested with 2.5 mAh/cm² NCM (less harsh condition) and the data for Example 5-1 was tested with 3.0 mAh/cm² NCM (harsher condition). Although the testing conditions were not identical, the difference confirms that the cross-linker in Example 5-1 shows better performance than the cross-linker in Example 5-2.

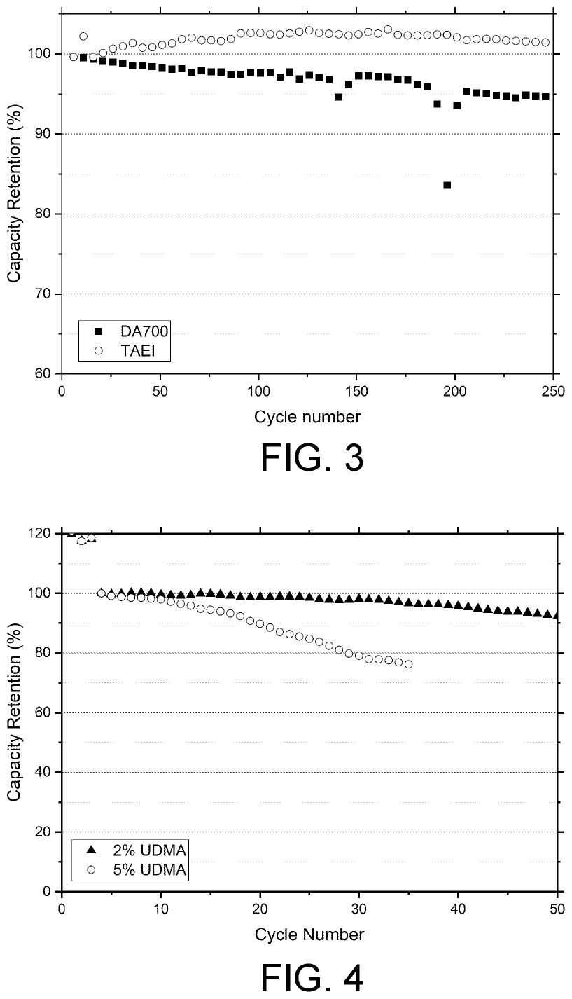

FIG. 3 shows the capacity retention of Example 5-1 and Example 5-2. At 250 cycles, Example 5-2 retains 94.3% of its original capacity, while Example 5-1 still has a capacity retention above 100%. Even though the two experiments were conducted with slightly different electrode loadings (Example 5-2 at a lower loading and less harsh condition (2.5 mAh/cm² cathode loading and 2.8 anode loading) and Example 5-1 at higher loading and harsher condition (3.0 mAh/cm² cathode loading and 3.3 mAh/cm2 anode loading)), the trend is consistent in showing that Example 5-1 shows superior stability than Example 5-2 by exhibiting superior capacity retention even under harsher conditions. The superior capacity retention of Example 5-1 is likely two folds. On the one hand, the cross-linker in Example 5-1 has three crosslinkable terminals as compared to two cross-linkable terminals in the cross-linker in Example 5-2. Therefore, the cross-linker in Example 5-1 can form polymer network more efficiently than the cross-linker in Example 5-2 with less amount used in the electrolyte system. On the other hand, the cross-linker in Example 5-1 contains imide functionality, which is stable at high voltages and also could facilitate ion transport in the polymer network. All of these properties contributes to the superior cycling stability of Example 5-1.

### Example 6

A solid-state polymer electrolyte was obtained by mixing a cross-linker (2 wt % UDMA for Example 6-1, 5 wt % UDMA for Example 6-2), an initiator (0.1 wt % AIBN), 3.5M lithium salts (bis(fluorosulfonyl)imide, LiFSI), and an additive by mechanical stirring at room temperature in the liquid state.

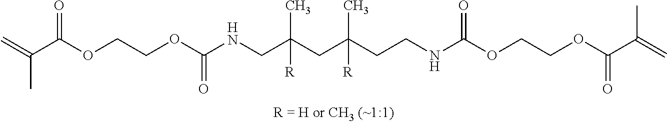

### Diurethane Dimethacrylate (UDMA)

The polymer solid electrolyte was assembled in a 2032-coin cell with Li foil as anode, NCM as cathode, and modified Senior as separator, and the as-assembled cell was thermally cured at 60° C. for 1 to 2 hours. The cycling test was performed with a Neware cycling tester. The charge/discharge voltage window was from 2.8 V to 4.2 V. The battery was cycled at a current rate of 0.05 C for the first cycle, then the battery was cycled at a current rate of 0.2 C from the second cycle to the third cycle, then the battery was charged with continuous current (CC) at a current rate of 0.5 C and discharged with continuous current (CC) at a current rate of 1 C for the next 500 cycles.

FIG. 4 shows the capacity retention curves of different amount of cross-linker UDMA in the formulation. As shown in FIG. 4, Example 6-1 retained 92% capacity retention after 50 cycles while in Example 6-2, the capacity reached 80% at 28th cycle. It shows that Example 6-2 is likely to limit the lithium ions transport in the polymer electrolyte network due to containing more cross-linker than Example 6-1, which causes more rapid capacity fade. While at less cross-linker amount in Example 6-1, lithium ions movement is not limited by the density of the crosslinked polymer network because the kinetic limitation is lessened. In addition, the N—R/N—H in the cross-linker in this example can facilitate lithium ions transport better than PEO chains.

### Example 7

A solid-state polymer electrolyte was obtained by mixing a cross-linker (1.5 wt % PETA), 4 M lithium salts (bis(fluorosulfonyl)imide, LiFSI), an initiator (0.1 wt % AIBN), and an additive by mechanical stirring at room temperature in the liquid state. The as-assembled cell was thermally cured at 60° C. for 1 to 2 hours.

The polymer solid electrolyte was assembled in a 2032-coin cell with Li foil as anode, and stainless steel spacer as cathode.

Cyclic voltammetry: a CR2032 coin cell (Stainless steel spacer for low voltage range or Al-clad for high voltage range) was used for CV cycling. A stainless steel spacer is used as the cathode and a lithium foil in the low voltage range, the Al-clad case was used directly as the cathode in the high voltage range. Electrolyte and separator were added between the cathode and the anode. Gamry 1010B potentiostat was used and the voltage range was defined as shown, scanning at 0.1 mV/s for 2 cycles.

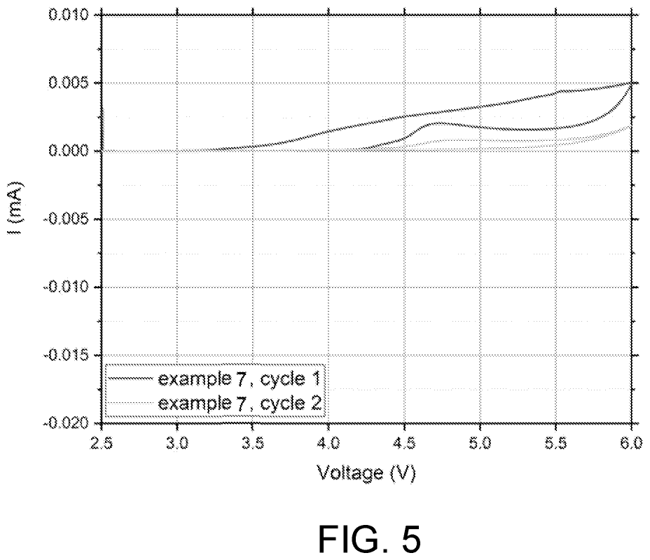

FIG. 5 shows that electrochemical stability was tested between 2-6V, and no other significant electrochemical or redox processes observed except for the small passivation process at 4.7V in cycle 1, and only minimal current was observed in cycle 2, indicating the formation of a passivation layer on the electrode upon oxidation. We believe that, the formation of such passivation layer is beneficial for the protection of electrodes and battery performance at high voltages. Within the voltage range examined, the polymer electrolyte formulation in FIG. 5 shows electrochemical stability up to 6V.

### Example 8

A solid-state polymer electrolyte was obtained by mixing a single cross-linker or dual cross-linkers, 3.5M LiFSI, an initiator (0.1 wt % AIBN), and an additive with ratios described below by mechanical stirring at room temperature in the liquid state.

The above mixture was applied to an ionic conductivity cell described below. The as-assembled cells were thermally curing at 60° C. for 1 to 2 hours. Electrochemical Impedance Spectroscopy (EIS) and ionic conductivity of the membrane were determined on the cells, as follows.

In Example 8, cross-linker 3 (tetraallyl silane), cross-linker 10 (SiO₂ 380), cross-linker 11 (SiO₂ 711), cross-linker 12 (SiO₂ 7200), cross-linker 7 (poly(ethylene glycol) diacrylate (Mn 700)), cross-linker 8 (pentaerythritol tetraacrylate), cross-linker 5 (2,4,6,8-tetramethyl-2,4,6,8-tetravinylcyclotetrasiloxane), cross-linker 13 (diallyl dimethylsilane), and cross-linker 14 (diurethane dimethacrylate) are utilized. Fumed silica (SiO₂) are obtained from commercial source, Evoniks, under the tradename Aerosil.

The cross-linkers were 4 wt % cross-linker 7 and 2 wt % cross-linker 10 for Example 8-1, and the ionic conductivity for Example 8-1 was 0.91 ms/cm.

The cross-linkers were 4 wt % cross-linker 7 and 2 wt % cross-linker 11 for Example 8-2, and the ionic conductivity for Example 8-2 was 0.97 ms/cm.

The cross-linkers were 4 wt % cross-linker 7 and 2 wt % cross-linker 12 for Example 8-3, and the ionic conductivity for Example 8-3 was 1.00 ms/cm.

The cross-linker was 1.5 wt % cross-linker 8 for Example 8-4, and the ionic conductivity for Example 8-4 was 1.23 ms/cm.

The cross-linkers were 1.5 wt % cross-linker 8 and 2 wt % cross-linker 3 for Example 8-5, and the ionic conductivity for Example 8-5 was 1.26 ms/cm.

The cross-linkers were 1.5 wt % cross-linker 8 and 2 wt % cross-linker 5 for Example 8-6, and the ionic conductivity for Example 8-6 was 1.04 ms/cm.

The cross-linkers were 1.5 wt % cross-linker 8 and 2 wt % cross-linker 13 for Example 8-7, and the ionic conductivity for Example 8-7 was 1.33 ms/cm.

The cross-linker was 2 wt % cross-linker 14 for Example 8-8, and the ionic conductivity for Example 8-8 was 1.52 ms/cm.

The cross-linker was 3 wt % cross-linker 14 for Example 8-9, and the ionic conductivity for Example 8-9 was 1.31 ms/cm.

Example 8-4, Example 8-8 and Example 8-9 are single cross-linker systems, and their respective ionic conductivities show that both cross-linker 8 and cross-linker 14 have improved ionic conductivities as compared to cross-linker 7. The improved ionic conductivity from cross-linker 8 is likely due to the tetraacrylate functionality, enabling it to crosslink from all four terminals rather than crosslinking linearly in cross-linker 7. As a result, less cross-linker of cross-linker 8 is used in the formulation, enabling faster lithium ions transport than that in cross-linker 7 formulations. For Example 8-8 and Example 8-9, cross-linker 14 can better facilitate lithium ion transport from the amide functionality, which is electron-donating and can enable lithium ion transport.

Example 8-5, Example 8-6 and Example 8-7 are dual cross-linker systems, and they show slightly improved ionic conductivities compared to Example 8-4, the single cross-linker system. The second cross-linkers added in Example 8-5, Example 8-6 and Example 8-7 are allyl/vinyl terminated silanes, which can cross-link and potentially be used in silicon-anode battery systems as additives. It is likely that the addition of a second cross-linker to the electrolyte system disrupted the cross-linker 8 crosslinking network, and a more disordered crosslinking network would likely lead to better ion transport, as ions can move more freely in the electrolyte. As the amount of the added cross-linkers are small, the disruption in ion transport property is also small, as observed.

### Example Summary

In summary, the incorporation of at least three cross-linkable terminals with UV crosslinked solidification appeared to considerably improve various electrochemical performances. These polymer solid electrolytes may help to achieve safe, long life lithium secondary batteries. In addition, the lack of poly(ethylene oxide) groups in the polymer chains can lead to a more stable material with higher decomposition potential. These properties may benefit the charging/discharging rate performances of lithium ions batteries. The improved decomposition potential of the polymer materials can also provide enhanced stability in solid state electrolytes, which may provide longer life and/or higher voltage lithium batteries. In addition, the polymer solid electrolytes in these examples did not use any organic solvents. Thus, they may reliably provide safe performance of lithium ions batteries, as well as other applications.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the invention includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An article, comprising:
a polymer comprising a product of a crosslinking reaction including at least one cross-linker selected from the group consisting of: a) di-acrylates, tri-acrylates, and tetra-acrylates; b) modified tri-acrylates and tetra-acrylates; c) silanes and siloxanes; and d) triazinane-triones.

2. The article of claim 1, wherein the at least one cross-linker has at least two cross-linkable terminals.

3. The article of claim 1, wherein the at least one cross-linker has vinyl and/or allyl as cross-linkable terminals.

4. The article of claim 1, wherein the at least one cross-linker is free of poly (ethylene oxide) polymer chain.

5. The article of claim 1, wherein a) di-acrylates, tri-acrylates, and tetra-acrylates is selected from the group consisting of: 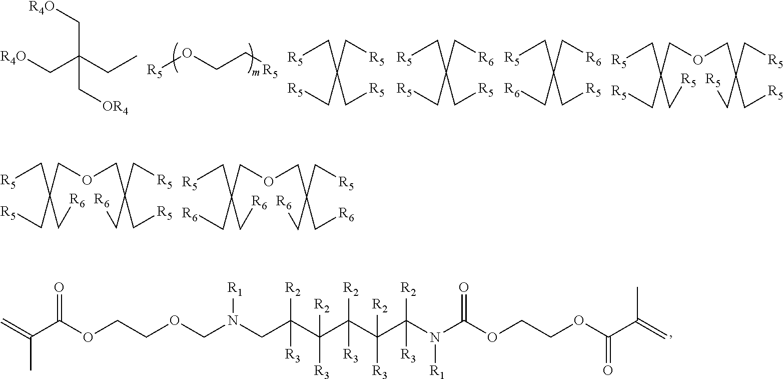
wherein R₁, R₂, R₃, R₆ are each independently selected from the group consisting of: 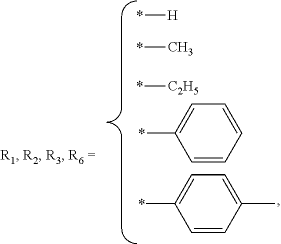
wherein R₄ is independently selected from the group consisting of: 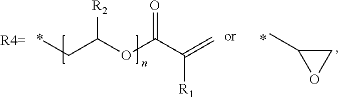
wherein R₅ is independently selected from the group consisting of: 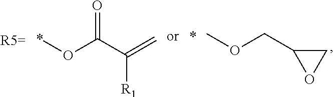
wherein m and n are respectively an integer between 0 and 50,000.

6. The article of claim 1, wherein b) modified tri-acrylates and tetra-acrylates is selected from the group consisting of: 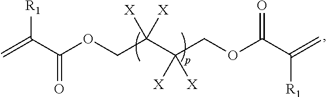
wherein p is an integer between 0 and 50,000,
wherein X is independently selected from the group consisting of:
X=—CN, —SO₂H, —CO₂H, —CO₂R₁, F, Cl, Br, I,
wherein R₁ is independently selected from the group consisting of:

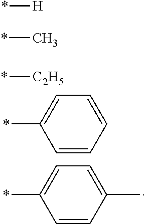

7. The article of claim 1, wherein c) silanes and siloxanes is selected from the group consisting of: 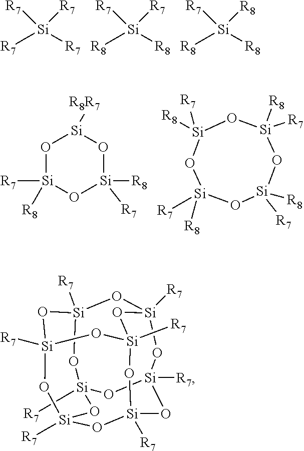
wherein R₇ is independently selected from the group consisting of: 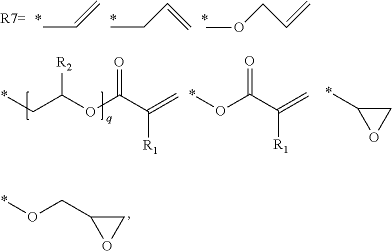
wherein R₁ and R₂ are each independently selected from the group consisting of: 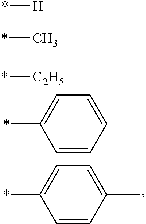
wherein q is an integer between 0 and 50,000,
wherein R₈ is independently selected from the group consisting of:

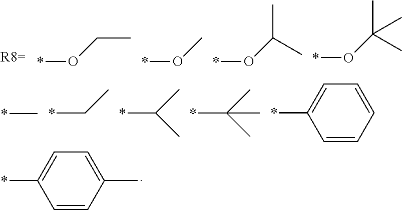

8. The article of claim 1, wherein d) triazinane-triones is selected from the group consisting of: 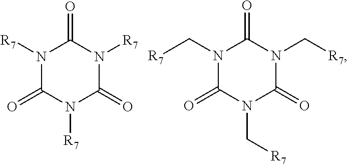
wherein R₇ is independently selected from the group consisting of: 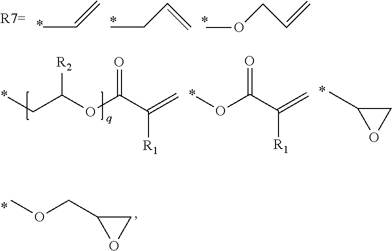
wherein * indicates a point of attachment,
wherein R₁ and R₂ are each independently selected from the group consisting of: 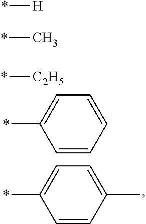
wherein q is an integer between 0 and 50,000.

9. The article of claim 1, wherein the at least one cross-linker has a total weight percentage between 0.1 wt % and 50 wt % based on a total weight of the article.

10. The article of claim 1, further comprising an additive and an electrolyte salt.

11. The article of claim 10, wherein the electrolyte salt comprises a lithium (Li) salt, and the lithium salt is selected from the group consisting of lithium perchlorate (LiClO₄), lithium hexafluorophosphate (LiPF₆), lithiumborofluoride (LiBF₄), lithium hexafluoroarsenide (LiAsF₆), lithium trifluoro-metasulfonate (LiCF₃SO₃), bis-trifluorom-ethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphates (LiPF₃(CF₂CF₃)₃), lithium bisperfluoro-ethysulfo-nylimide (LiBETI), lithium bis(trifluoromethanesulphonyl) imide, lithium bis(fuorosulphonyl)imide, lithium trifluoromethanesulfonimide (LiTFSI), lithium bis(fluo-rosulfonyl)imide (LiFSI), lithium difluoro(oxalato)borate (LiDFOB), lithium perchlorate (LiClO₄), LiC(CF₃SO₂)₃, LiF, LiCl, LiBr, LiI, Li₂SO₄, LiNO₃, Li₃PO₄, Li₂CO₃, LiOH, lithium acetate, lithium trifluoromethyl acetate, lithium oxalate, and a combination thereof.

12. The article of claim 10, wherein the additive comprises a polymer, a molecule having a molecular weight of less than 1 kDa, a nitrile, an oligoether, cyclic carbonate, or ionic liquids.

13. The article of claim 12, wherein the additive is selected from the group consisting of ethylene carbonate, diethyle carbonate, dimethyl carbonate, ethyl methyl carbonate, propylene carbonate, fluoroethylene carbonate, vinylene carbonate, succinonitrile, succinonitrile, glutaronitrile, hexonitrile, malononitrile, dimethyl sulfoxide, prop-1-ene-1,3-sultone, sulfolane, ethyl vinyl sulfone, tetramethylene sulfone, vinyl sulfone, methyl vinyl sulfone, phenyl vinyl sulfone, N-propyl-N-methylpyrrolidinium bis(fluorosulfonyl)imide, 1-ethyl-3-methylimidazolium bis(fluorosulfonyl)imide, trimethyl phosphate, triethyl phosphate, and poly(ethylene oxide).

14. The article of claim 10, further comprising an initiator, wherein the initiator comprises Irgacure initiator, 2,2′-azobis(2-methylpropionitrile), benzoyl peroxide, cumene hydroperoxide, dicumyl peroxide, ter-butyl hydroperoxide, di-tert-butyl peroxide, 2,2′-azobis[2-(2-imidazoline-2-yl)propane] dihydrochloride, ammonium persulfate, anisoin, anthraquinone, benzophenone, benzoin methyl ether, 2-isopropylthioxanthone, 9,10-phenanthrenequinone, 3′-hydroxyacetophenone, 3,3′,4,4′-benzophenonetetreacarboxylic dianhydride, 2-benzoylbenzoic acid, (±)-camphorquinone, 2-ethylanthraquinone, 2-methylbenzophenone, 4-hydroxybenzophenone, 2-hydroxy-2-methylpropiophenone, benzoin isobutyl ether, 4,4′-bis(dimethylamino)benzophenone, 4,4′-dihydroxybenzophenone, 4-benzoyl 4′-methyldiphenyl sulfide, ferrocene, dibenzosuberenone, benzoin ethyl ether, benzil, methyl benzoylformate, 4-benzoylbenzoic acid.

15. The article of claim 14, wherein a weight percentage of the initiator is between 0.01 wt % and 5 wt % based on a total weight of the article.

16. An electrochemical device, comprising the article of claim 1.

17. The electrochemical device of claim 16, wherein the electrochemical device is a battery, a lithium-ion battery, or a lithium-ion solid-state battery.

18. The electrochemical device of claim 16, wherein the electrochemical device comprises an anode and a cathode with an electroactive material.

19. The electrochemical device of claim 18, wherein the anode comprises carbon anode, Li anode, Si anode, Alloy anode, Li₄Ti₅O₁₂, and/or conversion anode materials, wherein the carbon anode comprises graphite, soft carbon, hard carbon, or combinations of thereof, the Li anode comprises Li metal foil, Li metal on Cu, Ni, or stainless steel, the Si anode comprises Si, Si/Carbon composite anode, SiOₓ (0≤x<2), SiOₓ (0≤x<2)/carbon composite anode, the Alloy anode comprises Sn, SnO₂, Sb, Al, Mg, Bi, In, As, Zn, Ga, B, and the conversion anode materials comprise MₐX_{b}, M is Mn, Fe, Co, Ni, or Cu, X is O, S, Se, F, N, or P, a and b are respectively 1 to 4.

20. The electrochemical device of claim 18, wherein the electroactive material is selected from the group consisting of lithium nickel cobalt manganese oxide, lithium nickel cobalt aluminum oxide, lithium titanate, metallic lithium, lithium metal oxide, lithium manganese oxide, lithium cobalt oxide, and lithium iron phosphate.

21. The electrochemical device of claim 16, wherein the electrochemical device is anode free battery.
